(19) United States
(12) Patent Application Publication
(10) Pub. No.: US 2010/0232327 A1
(43) Pub. Date: Sep. 16, 2010

(54) METHOD FOR HANDOVER PROCEDURE OF USER TERMINAL DURING POWER SAVING OPERATION IN CELLULAR SYSTEM

(75) Inventors: Jae-Heung Kim, Daejon (KR); Jung-Im Kim, Daejon (KR); Kyoung-Seok Lee, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTIU, DAEJEON (KR)

(21) Appl. No.: 12/515,233

(22) PCT Filed: Nov. 16, 2007
(86) PCT No.: PCT/KR07/05776

§ 371 Date: May 15, 2009

(30) Foreign Application Priority Data
Nov. 16, 2006 (KR) 10-2006-0113109

(51) Int. Cl. H04W 36/00; G08C 17/02

(52) U.S. Cl. 370/311; 370/331

(57) ABSTRACT

Provided is a handover method for user terminals operating in a power-saving mode while minimizing time delay in a packet-based cellular system. The handover method includes the steps of: deciding whether to perform handover based on information transmitted from a source base station; transmitting an uplink synchronization acquisition request to a target base station selected according to a decision for performing handover and requesting the target base station for uplink radio resources; and transmitting a handover request message to the target base station based on uplink radio resources allocated by the target base station by performing control according to a radio link control command transmitted from the target base station.

### TECHNICAL FIELD

The present invention relates to a handover method for a user terminal operating in a power-saving mode in a cellular system; and, more particularly, to a handover method for user terminals operating in a power-saving mode while minimizing time delay in a packet-based cellular system.

### BACKGROUND ART

Packet-based cellular systems are now under discussion for standardization and it is expected that an Orthogonal Frequency Division Multiplexing Access (OFDMA) is selected as standard technology. OFDMA systems have radio resources of a two-dimensional structure, which is frequency and time. This means that OFDMA systems separately transmit radio resources formed of time and frequency in downlink and uplink physical channels. The radio resources use radio resource blocks divided into a Transmission Time Interval (TTI) group and a sub-carrier group.

Referring to FIG. 1, a handover method in a Wideband Code Division Multiple Access (WCDMA) cellular system will be described. The handover method performed in a WCDMA cellular system is referred to backward handover. Typical backward handover method will be described in detail, hereinafter.

When mobile user terminals enter a handover region in the middle of communicating with a source base station, the source base station performs handover onto active-state user terminals that are not executing a power-saving operation for reducing the amount of power consumption.

In step S101, an active-state user terminal receives adjacent cell information and threshold information related to handover that are broadcasted from the source base station. In step S102, the active-state user terminal reports downlink channel quality information of adjacent cells and a home cell to the source base station. The downlink channel quality information of adjacent cells and a home cell that are reported to the source base station are delivered to a handover controller which is in charge of control for handover. When it is decided that the active-state user terminal needs handover, the active-state user terminal transmits a handover request message to the source base station in step S103.

In step S104, the source base station and the handover controller that have received the handover request message from the active-state user terminal select a target base station appropriate for the user terminal among adjacent base stations through network information exchange. In step S105, the handover controller requests the selected target base station to allocate radio resources for the user terminal that has requested for handover. In step S106, the handover controller receives a response to the radio resource allocation request from the target base station.

The target base station transmits radio resource information reserved for the user terminal to the source base station in the meaning of allowing handover. In step S107, the source base station transmits the radio resource information to the user terminal along with a handover execution message.

With the handover execution message, in step S108, the target base station information, and the radio resource information, the user terminal accesses to the target base station by using the allocated radio resource information and transmits a handover completion message. Accordingly, the user terminal completes the handover and communicates with the target base station in step S109.

When the target base station receives the handover completion message from the user terminal in the step S108, it transmits a radio resource release message for the user terminal to the source base station in step S110, and receives a response to the radio resource release message in step S111 to thereby complete the handover process in the base stations.

To sum up the conventional backward handover method described above, a user terminal receives radio resources of a target base station allocated thereto through a source base station before the user terminal releases radio resources of the source base station and accesses to the target base station by using the allocated radio resources.

Meanwhile, OFDMA cellular systems provide a service by allocating sub-carriers within the band of a base station to user terminals within the coverage of the base station. The base station transmits a transmission timing control message to the user terminals through a downlink control channel to secure an uplink orthogonal property among the user terminals using the sub-carriers allocated thereto. Accordingly, the base station can control transmission timing in such a manner that all user terminals on service can receive sub-carrier receiving signals within a predetermined guard interval.

Therefore, the handover completion message transmitted from a user terminal to a target base station in the handover process requires to be transmitted using uplink timing control information. The acquisition of uplink timing control information in the user terminal can be carried out through the following process.

Terminals may use an initial random access process or, similarly, it may transmit a predetermined signal sequence (such as a preamble) or signatures to a base station. The base station executes a timing control process for deciding uplink timing control information based on the information transmitted from the user terminals and sends timing control information (e.g., timing advance information) back to the user terminals. The user terminals control uplink timing based on the timing control information transmitted from the base station and transmit a handover completion message to the base station.

In a packet-based cellular system, a user terminal can maintain diverse states according to whether a network is registered or whether packets are transmitted/received. FIG. 2 exemplary shows a state of a terminal managed by a base station for packet transmission.

A cellular system for a packet service defines states of user terminals according to their extent of connection shown in FIG. 2 and performs management to effectively use radio resources whose amount is limited in a network including a base station.

Attached mode 21 signifies a state that a user terminal is registered into a network through a base station. Detached mode 22 is a state that a user terminal is not recognized in a cellular network including a base station, or a state that a user terminal is not registered.

User terminals in the attached mode are divided into those in an active state 23 and those in an idle state 24 according to whether a packet service is provided or not. Active-state user terminals are also divided into those in a packet-on state 25 and those in a discontinuous reception (DRX) or a discontinuous transmission (DTX) 26. The packet-on state is a state where a user terminal transmits/receives packet data by using radio resources allocated under the control of a scheduler disposed in a base station or a state where a user terminal maintains physical layer synchronization without uplink packet data transmission/reception.

The discontinuous transmission/reception state signifies a state where a base station and a user terminal do not have data to transmit/receive for a predetermined time while being in the active state where they maintain connection over level 3, and execute a power-saving operation without maintaining uplink physical layer synchronization. In short, the discontinuous transmission/reception state is a state where a user terminal does not have data to transmit/receive according to a burst characteristic of packet data, or a scheduler of the base station operates in a transmission suspension mode for some reason and thus does not allocate radio resources for transmitting/receiving packet data and control information. User terminals in the discontinuous transmission/reception state perform the power-saving operation without maintaining the uplink physical layer synchronization at a discontinuous transmission/reception period which is set up through communication with the base station.

In the OFDMA cellular system, user terminals should be allocated by a scheduler of a base station with uplink radio resources to transmit packet data in the uplink. User terminals should acquire synchronization control information for an uplink physical layer controlled by a base station in order to secure an orthogonal property between packet data transmitted in the uplink by using radio resources of sub-carriers allocated to them and packet data transmitted in the uplink by using radio resources of sub-carriers allocated to other user terminals in the same transmission timing interval.

According to the conventional backward handover process, when a user terminal in the discontinuous transmission/reception state where the user terminal performs the power saving operation in the active state without maintaining the physical layer synchronization enters a handover region and request a handover process, the handover is performed as follows.

At first, since the user terminal does not maintain physical layer synchronization, it performs procedures for acquiring uplink synchronization and receiving radio resources allocated thereto to transmit a handover request message in the uplink. The timing acquisition request and the uplink radio resource request can be carried out by simultaneously performing procedures of acquiring uplink physical layer synchronization and receiving uplink radio resources allocated thereto through the initial random access process or by respectively controlling timing individually defined in a system (that is, performing a timing advance process) and making an uplink radio resource request. User terminals with the uplink physical layer synchronization and radio resources allocated thereto begin handover by transmitting a handover request message to a source base station.

When user terminals receive handover information on a target base station from the source base station and the handover information does not have information on controlling uplink physical layer synchronization with the target base station, they execute a process of acquiring uplink physical layer synchronization with the target base station by performing an initial random access process to the target base station once again or additionally performing a timing control process to acquire physical layer synchronization with the target base station.

When handover is carried out in an OFDMA cellular system using the conventional backward handover method, it takes much time, and the initial random access process for uplink synchronization acquisition or the additional timing control process should be performed in both source base station and target base station, individually.

### DISCLOSURE

### Technical Problem

An embodiment of the present invention which is devised to overcome the problems of the conventional technologies is directed to providing a handover method that can minimize time delay caused by handover in active-state user terminals which perform a low-power consuming operation without maintaining uplink physical layer synchronization under the control of a base station in a packet-based OFDMA cellular system.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a handover method for a user terminal in a cellular system, which includes: (a) deciding whether to perform handover based on information transmitted from a source base station; (b) transmitting an uplink synchronization acquisition request to a target base station selected according to a decision for performing handover and requesting the target base station for uplink radio resources; (c) transmitting a handover request message to the target base station based on uplink radio resources allocated by the target base station by performing control according to a radio link control command transmitted from the target base station; and (d) upon receipt of a handover execution message transmitted from the target base station, transmitting a handover completion message as a response.

In accordance with another aspect of the present invention, there is provided a handover method for a base station in a cellular system, which includes the steps of: (a) receiving an uplink synchronization acquisition request and an uplink radio resource request from a user terminal as the user terminal decides to perform handover; (b) transmitting a radio link control command and information on allocated uplink radio resources in response to the uplink synchronization acquisition request and the uplink radio resource request; (c) receiving a handover request message controlled according to the radio link control command from the user terminal based on the allocated uplink radio resources; (d) deciding whether to approve the handover by interlocking with a source base station based on information included in the handover request message; and (e) transmitting a handover execution message to the user terminal according to a decision approving the handover and receiving a handover completion message as a response thereto.

In accordance with another aspect of the present invention, there is provided a handover method for a user terminal in a cellular system, which includes the steps of: (a) deciding whether to perform handover based on information transmitted from a source base station; (b) transmitting an uplink synchronization acquisition request to a target base station selected as the user terminal decides to perform handover and requesting the target base station for uplink radio resources; (c) transmitting a handover request message to the target base station based on uplink radio resources allocated by the target base station by performing control according to a radio link control command transmitted from the target base station; and (d) deciding whether to approve the handover in the target base station, and receiving a handover completion message from the target base station as the target base station decides to approve the handover.

In accordance with another aspect of the present invention, there is provided a handover method for a base station in a cellular system, which includes the steps of: (a) receiving an uplink synchronization acquisition request and an uplink radio resource request from a user terminal as the user terminal decides to perform handover; (b) transmitting a radio link control command and information on allocated uplink radio resources in response to the uplink synchronization acquisition request and the uplink radio resource request; (c) receiving a handover request message controlled according to the radio link control command from the user terminal based on the allocated uplink radio resources; (d) deciding whether to approve the handover by interlocking with a source base station based on information included in the handover request message; and (e) transmitting a handover completion message to the user terminal as the base station decides to approve the handover.

In accordance with another aspect of the present invention, there is provided a handover method for a user terminal in a cellular system, which includes the steps of: (a) deciding whether to perform handover based on information transmitted from a source base station; (b) transmitting an uplink synchronization acquisition request to a target base station selected according to a decision for performing handover and requesting the target base station for uplink radio resources; and (c) transmitting a handover request message to the target base station based on uplink radio resources allocated by the target base station by performing control according to a radio link control command transmitted from the target base station.

### Advantageous Effects

The handover method of the present invention described above can request handover to a target base station by receiving radio resources of the target base station allocated thereto and minimize time delay caused by the handover in active-state user terminals which perform a low-power consuming operation without maintaining uplink physical layer synchronization under the control of a base station in a packet-based OFDMA cellular system.

### BRIEF DESCRIPTION OF THE DRAWINGS

FIG. 1 describes a typical backward handover method.

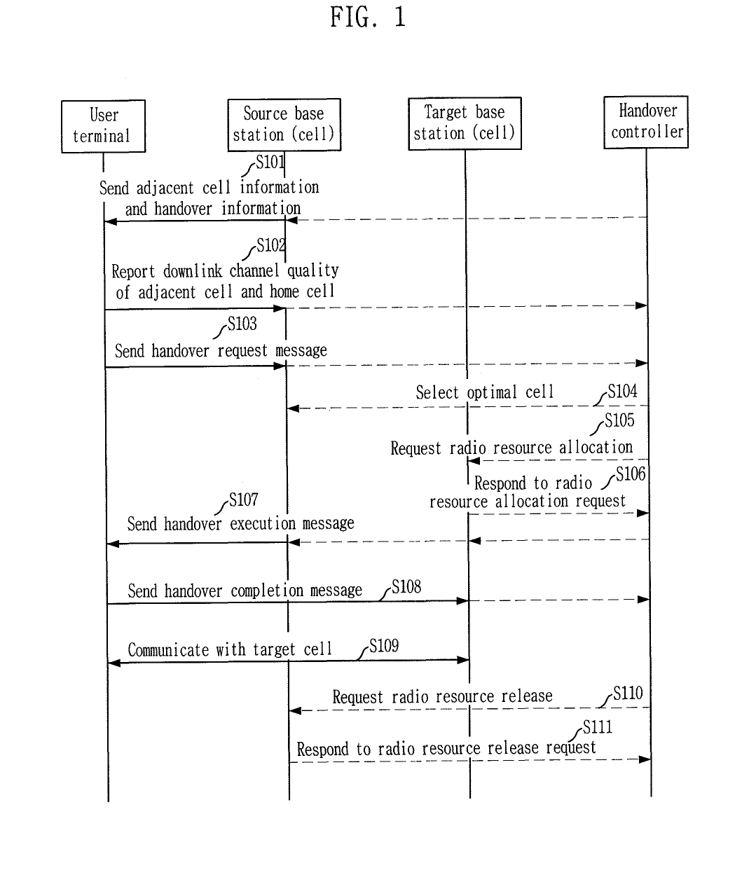

FIG. 2 shows the state of a user terminal managed by a base station for a packet service.

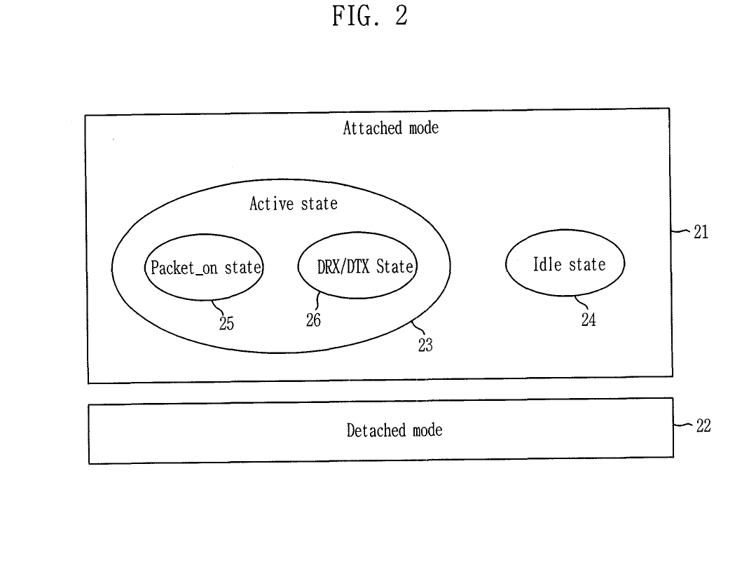

FIG. 3 shows a forward handover method in accordance with an embodiment of the present invention.

FIG. 4 shows a forward handover method in accordance with another embodiment of the present invention.

### BEST MODE FOR THE INVENTION

The advantages, features and aspects of the invention will become apparent from the following description of the embodiments with reference to the accompanying drawings, which is set forth hereinafter. When it is considered that detailed description on a related art may obscure the points of the present invention, the description will not be provided herein. Hereinafter, specific embodiments of the present invention will be described with reference to the accompanying drawings.

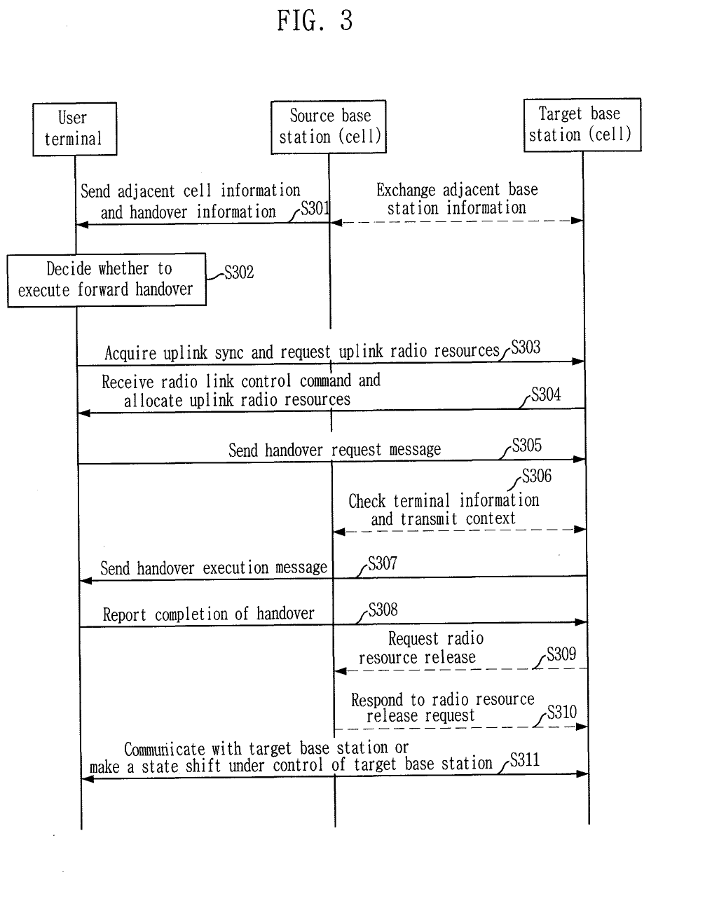

FIG. 3 shows a handover method performed in an active-state user terminal executing a power-saving operation without maintaining uplink physical layer synchronization in accordance with an embodiment of the present invention.

When handover is required, active-state user terminals executing a power saving operation without maintaining uplink physical layer synchronization receive radio resources directly allocated by a target base station and request the target base station for handover based on the allocated radio resources. The handover method of the present invention is referred to as a forward handover method.

The method of the present invention simplifies a handover process and executes handover in a source base station and a target base station to optimize a system. This is different from a conventional handover method in which a handover controller controls handover. In short, base stations directly control a handover process in the method of the present invention. According to the present invention, when a user terminal of a discontinuous transmission/reception state which performs a power-saving operation without maintaining physical layer synchronization in an active state enters a handover region, the user terminal decides whether to perform handover as illustrated in FIG. 3. The user terminal begins handover as it directly transmits a handover request message to a target base station, instead of a source base station. The forward handover method of the present invention will be described in detail with reference to FIG. 3.

A user terminal of a discontinuous transmission/reception state which performs a power-saving operation without maintaining physical layer synchronization in an active state enters a handover region wakes up according to a discontinuous transmission period and a discontinuous reception period and measures signal intensities of adjacent base stations. The user terminal also acquires information on the adjacent base stations that is broadcasted from the source base station. Subsequently, the user terminal executes the power-saving operation in which it sleeps until the next discontinuous transmission/reception period.

According to the present invention, in step S301, the adjacent base stations exchange their information with each other, and the source base station broadcasts information on adjacent base stations available for handover and handover threshold information to user terminals performing a power-saving operation in the active state periodically or upon a request for them. In other words, the source base station broadcasts to the user terminals reference parameters for deciding forward handover, such as the identifiers of base stations available for forward handover among the adjacent base stations, signal level threshold values for forward handover between target base station and source base station, time fulfilling the signal level threshold values for forward handover between target base station and source base station and the like, based on the adjacent base station information collected through network communication.

In step S302, the user terminals of the discontinuous transmission/reception state which performs the power-saving operation without maintaining physical layer synchronization in the active state decides whether to execute the forward handover based on the adjacent base station information and handover threshold information that are collected from the source base station. When the source base station does not broadcast the adjacent base station information, the user terminals may request the source base station for the adjacent base station information through a separate channel and acquires the adjacent base station information, or they may select a base station, or a best cell, based on adjacent base station information acquired with a cell search function of the user terminals without going through the process for acquiring the adjacent base station information and decide whether to perform the handover.

The user terminals decide to perform the forward handover when an adjacent base station available to be a target base station among the adjacent base stations available for handover sends out signals equal to or stronger than the signals of the source base station by a predetermined level and the state where the signals are strong lasts longer than a predetermined time.

When the handover is needed, in step S303, the user terminals transmit an uplink synchronization acquisition request to the selected target base station through the initial random access procedure (or an individual procedure for forward handover) and, at the same time, request it to allocate uplink radio resources. Herein, the initial random access procedure includes the steps of transmitting a preamble from a user terminal to the base station, detecting the preamble and allocating radio resources in the base station, and transmitting the radio resources to the user terminal. Since diverse methods are already suggested for the initial random access, further description on the initial random access will not be provided herein. The additional procedure for the handover is to execute a process of controlling timing reserved for the forward handover and requesting uplink radio resource allocation.

When the target base station receives an uplink synchronization request and an uplink radio resource request from the user terminal, it transmits a response including uplink synchronization control information for the user terminal (or uplink power control information) and information on the allocated uplink radio resources to the user terminal. In step S304, the user terminal receives a radio link control command including uplink synchronization control information (or uplink power control information) from the target base station and receives uplink radio resources allocated thereto.

Upon receipt of the radio link control command, in step S305, the user terminal transmits the handover request message requesting for forward handover to the target base station by using the allocated uplink radio resources and adjusting the timing for uplink synchronization (or timing and transmission power). The handover request message may include source base station information having a source base station identifier and terminal information including information on whether there are data to be transmitted.

The target base station receiving a handover request message from the user terminal checks information on the user terminal in the source base station through network communication based on the source base station information and the terminal information in the handover request message, and decides whether to approve the handover. When the target base station decides to approve the handover, in step S306, it requests the source base station to transmit context of the user terminal and data.

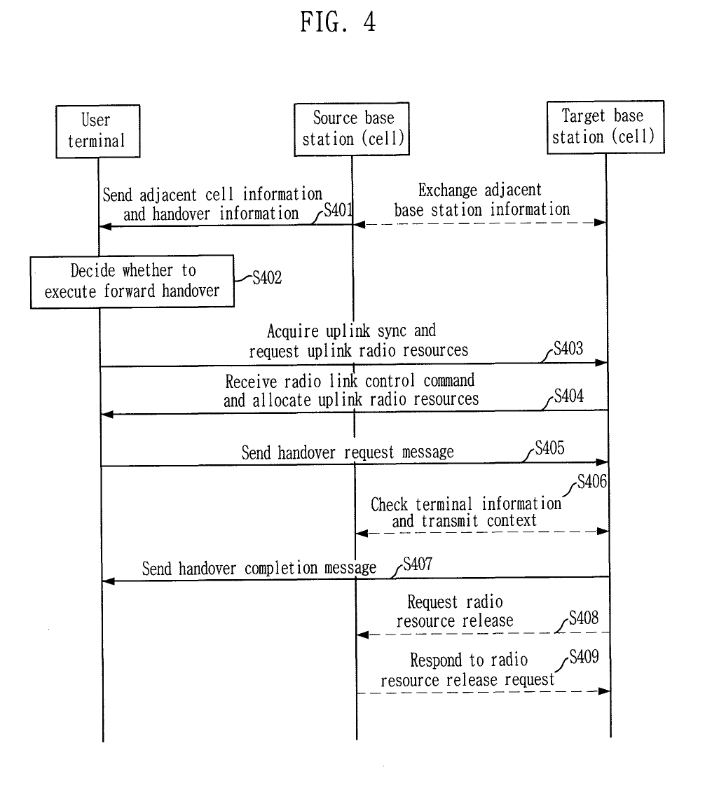

When the information checking with the source base station is completed, the target base station terminates the forward handover process in one of the following two methods in consideration of the terminal information which is included in the handover request message transmitted from the user terminal and includes information on whether the user terminal has data to transmit, the terminal context information transmitted from the source base station, and the load state of the base station. One of the two methods for terminating the forward handover is to receive a handover completion message from the user terminal and terminates the forward handover process (see FIG. 3). The other is to transmit a handover completion message from the target base station and terminates the forward handover process (see FIG. 4).

Referring to FIG. 3, the method of terminating forward handover by receiving a handover completion message from a user terminal will be described first.

In step S307, the target base station transmits a handover execution message to the user terminal. Herein, the target base station may transmit uplink radio resource information, which is used for the user terminal to transmit a handover completion message, along with a handover execution message.

Upon receipt of the handover execution message from the target base station, the user terminal transmits a handover completion message based on the allocated uplink radio resources in step S308. In step S309, the target base station receives the handover completion message from the user terminal and requests the source base station to lease the radio resources from the user terminal and receives a response to the radio resource release request in step S310.

The target base station can control the state of the user terminal according to whether there are data to be transmitted to or received by the user terminal to transmit/receive data or it can shift the user terminal state into the power-saving operation mode in the active state or into an idle state in step S311.

Referring to FIG. 4, termination of handover by transmitting a handover completion message from the target base station will be described hereinafter.

FIG. 4 shows a forward handover method in accordance with another embodiment of the present invention. Steps S401 to 406 shown in FIG. 4 are the same as the counterpart steps shown in FIG. 3.

In step S407, when the target base station decides to approve the handover, the target base station transmits a handover completion message to the user terminal. Herein, the target base station transmits the handover completion message and a power-saving operation parameter including period information of discontinuous transmission/reception to be performed in the active state to the user terminal so that it can control the user terminal to keep on executing the power-saving operation in the active-state in the coverage of the target base station or to wait for additional scheduling information.

In step S408, the target base station transmits a radio resource release request message for releasing the radio resources for the user terminal to the source base station without going through a process of receiving a handover completion message from the user terminal and, in step S409, it receives a response to the radio resource release request message.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The present invention provides a handover method that can minimize time delay in user terminal performing a power-saving operation in a packet-based cellular system.

What is claimed is:

1. A handover method for a user terminal in a cellular system, comprising:
(a) deciding whether to perform handover based on information transmitted from a source base station;
(b) transmitting an uplink synchronization acquisition request to a target base station selected according to a decision for performing handover and requesting the target base station for uplink radio resources;
(c) transmitting a handover request message to the target base station based on uplink radio resources allocated by the target base station by performing control according to a radio link control command transmitted from the target base station; and
(d) upon receipt of a handover execution message transmitted from the target base station, transmitting a handover completion message as a response.

2. The handover method of claim 1, wherein in the step (a), the information transmitted from the source base station includes information on adjacent base stations, a signal level threshold value for handover between the target base station and the source base station, and time information fulfilling the signal level threshold value for handover between the target base station and the source base station.

3. The handover method of claim 1, wherein in the step (b), the uplink synchronization acquisition request and the uplink radio resource request, and responses thereto are made in an initial random access.

4. The handover method of claim 1, wherein in the step (b), the uplink synchronization acquisition request and the uplink radio resource request, and responses thereto are made based on system information broadcasted from the target base station.

5. The handover method of claim 1, wherein in the step (c), the handover request message includes terminal information including information on the source base station and information on whether there are data to be transmitted.

6. The handover method of claim 1, wherein in the step (d), radio resource information on radio resources allocated to transmit the handover completion message is received along with the handover execution message, and the handover completion message is transmitted to the target base station based on the radio resource information.

7. A handover method for a base station in a cellular system, comprising the steps of:
(a) receiving an uplink synchronization acquisition request and an uplink radio resource request from a user terminal as the user terminal decides to perform handover;
(b) transmitting a radio link control command and information on allocated uplink radio resources in response to the uplink synchronization acquisition request and the uplink radio resource request;
(c) receiving a handover request message controlled according to the radio link control command from the user terminal based on the allocated uplink radio resources;
(d) deciding whether to approve the handover by interlocking with a source base station based on information included in the handover request message; and
(e) transmitting a handover execution message to the user terminal according to a decision approving the handover and receiving a handover completion message as a response thereto.

8. The handover method of claim 7, further comprising the step of:
transmitting a radio resource release request for the user terminal to the source base station and receiving a response thereto after the step (e).

9. The handover method of claim 7, wherein the handover request message includes information on the source base station and terminal information having information on whether there are data to be transmitted.

10. The handover method of claim 9, wherein the step (d) includes the steps of:
deciding whether to approve the handover by checking information on the user terminal transmitted from the source base station based on the information on the source base station and the terminal information; and
requesting the source base station to transmit context of the user terminal and data.

11. The handover method of claim 7, wherein the step (e) includes the step of:
transmitting information on radio resources allocated to transmit the handover completion message along with the handover execution message to the terminal.

12. A handover method for a user terminal in a cellular system, comprising:
(a) deciding whether to perform handover based on information transmitted from a source base station;
(b) transmitting an uplink synchronization acquisition request to a target base station selected as the user terminal decides to perform handover and requesting the target base station for uplink radio resources;
(c) transmitting a handover request message to the target base station based on uplink radio resources allocated by the target base station by performing control according to a radio link control command transmitted from the target base station; and
(d) deciding whether to approve the handover in the target base station, and receiving a handover completion message from the target base station as the target base station decides to approve the handover.

13. The handover method of claim 12, wherein in the step (a), the information transmitted from the source base station includes information on adjacent base stations, a signal level threshold value for handover between the target base station and the source base station, and time information fulfilling the signal level threshold value for handover between the target base station and the source base station.

14. The handover method of claim 12, wherein in the step (b), the uplink synchronization acquisition request and the uplink radio resource request, and responses thereto are made in an initial random access.

15. The handover method of claim 12, wherein in the step (b), the uplink synchronization acquisition request and the uplink radio resource request, and responses thereto are made based on system information broadcasted from the target base station.

16. The handover method of claim 12, wherein in the step (c), the handover request message includes terminal information including information on the source base station and information on whether there are data to be transmitted.

17. The handover method of claim 12, wherein the step (d) includes the step of: receiving a handover completion message and a power-saving operation parameter which includes period information of reception and transmission to be performed in an active state from the target base station.

18. A handover method for a base station in a cellular system, comprising the steps of:
(a) receiving an uplink synchronization acquisition request and an uplink radio resource request from a user terminal as the user terminal decides to perform handover;
(b) transmitting a radio link control command and information on allocated uplink radio resources in response to the uplink synchronization acquisition request and the uplink radio resource request;
(c) receiving a handover request message controlled according to the radio link control command from the user terminal based on the allocated uplink radio resources;
(d) deciding whether to approve the handover by interlocking with a source base station based on information included in the handover request message; and
(e) transmitting a handover completion message to the user terminal as the base station decides to approve the handover.

19. The handover method of claim 18, further comprising the step of:
transmitting a radio resource release request for the user terminal to the source base station and receiving a response thereto after the step (e).

20. The handover method of claim 18, wherein the handover request message includes information on the source base station and terminal information having information on whether there are data to be transmitted.

21. The handover method of claim 20, wherein the step (d) includes the steps of:
deciding whether to approve the handover by checking information of the user terminal transmitted from the source base station based on the information on the source base station and the terminal information; and
requesting the source base station to transmit context of the user terminal and data.

22. The handover method of claim 18, wherein the step (e) includes the step of:
transmitting a power-saving operation parameter which includes period information of reception and transmission to be performed in an active state to the terminal, along with a handover completion message.

23. A handover method for a user terminal in a cellular system, comprising:
(a) deciding whether to perform handover based on information transmitted from a source base station;
(b) transmitting an uplink synchronization acquisition request to a target base station selected according to a decision for performing handover and requesting the target base station for uplink radio resources; and
(c) transmitting a handover request message to the target base station based on uplink radio resources allocated by the target base station by performing control according to a radio link control command transmitted from the target base station.
